(19) United States
(12) Patent Application Publication
(10) Pub. No.: US 2021/0380079 A1
(43) Pub. Date: Dec. 9, 2021

(54) Lever System

(71) Applicant: Dextera Brakes, LLC, Winnetka, IL (US)

(72) Inventors: Todd Vorhies, Sandpoint, ID (US); John Doane Nichols, III, Winnetka, IL (US); Nathaniel Bartholomew Egging, Bellingham, WA (US)

(21) Appl. No.: 16/892,112

(22) Filed: Jun. 3, 2020

(51) Int. Cl. B60T 7/10; B62L 3/02

(52) U.S. Cl. CPC B60T 7/102; B62L 3/023

(57) ABSTRACT

The disclosure relates to a lever system using a linkage assembly for creating linear movement from a rotational movement of a lever. The lever system may be arranged as a grip assembly to activate a braking system of a vehicle. The linkage assembly may include a slide linkage, a bearing linkage, and a pivot linkage such that the lever may cause an end of the bearing linkage and an end of the pivot linkage to move toward the slide linkage, which causes the slide linkage to move in a linear direction.

### TECHNICAL FIELD

Aspects of the disclosure relate to actuation systems in general related to lever assemblies contained within an enclosure or at least partially within an enclosure.

### BACKGROUND

Many types of mechanical devices may be used to activate different types of mechanisms. Lever and linkage assemblies may be used to reduce the force needed to activate a mechanical system or change a force exerted in one direction to cause movement in a different direction. As an example, in braking or throttle systems for vehicles, such as a bicycles or motorcycles, an externally mounted lever may be utilized to exert a force on a cable or hydraulic braking system to activate the brakes. However, the externally mounted lever may be cumbersome and difficult for some users to operate.

### SUMMARY

This Summary introduces some general concepts relating to this disclosure in a simplified form that are further described below in the Detailed Description. This Summary is not intended to identify key features or essential features of the disclosure.

In some aspects, this disclosure may relate to a lever system that includes a housing, a lever, and a linkage assembly. The housing may have a first end, a second end opposite the first end, and a housing body extending between the first end and the second end, where the first end has a first opening that extends into an interior cavity, and a second opening on a lower portion of the housing that extends into the interior cavity. The first axis may define a longitudinal axis of the grip assembly. The lever may have a first end that is pivotally engaged at a first location with the housing, a second end opposite the first end, and a lever body extending between the first end and the second end. The linkage assembly may include: (a) a slide linkage having a first end, a second end opposite the first end, and a slide linkage body extending between the first end and the second end; (b) a bearing linkage having a first end pivotally engaged with the slide linkage and a second end opposite the first end; and (c) a pivot linkage having a first end pivotally engaged with the housing at a second location and also slidably engaged with the slide linkage and a second end opposite the first end that is pivotally engaged with the second end of the bearing linkage. When the lever rotates toward the interior cavity, the second end of the bearing linkage and the second end of the pivot linkage may both move toward the slide linkage causing the slide linkage to move along the longitudinal axis. In some examples, the slide linkage may move toward the first opening when the lever rotates toward the interior cavity, while in other examples, the slide linkage may moves away from the first opening when the lever rotates toward the interior cavity. The slide linkage may have a receiver near the first end that receives a cable, where the cable is part of a braking system for a vehicle. The slide linkage may connect to a piston that is configured to attach to a hydraulic line of a braking system for a vehicle. The second end of the bearing linkage and the second end of the pivot linkage may be connected to a first roller bearing. The lever body may include a pocket with a bottom surface, where the first roller bearing contacts the bottom surface. The first end of the lever may be enclosed within the housing and a portion of the lever body extends through the second opening. The housing may include an edge on the second opening that provides a stop to limit rotation of the lever in a direction away from the interior cavity. The housing body may include a first member having the first opening and a curved upper surface and a second member having the second opening, where the interior cavity is formed when the first member and the second member are joined together. The first member and the second member may be releasably joined together.

Other aspects of this disclosure may relate to a grip assembly that includes a housing, a lever, and a linkage assembly. The housing may have a first end, a second end opposite the first end, and a housing body extending between the first end and the second end, where the first end has a first opening that extends into an interior cavity, and a second opening on a lower portion of the housing that extends into the interior cavity. The first opening may define a longitudinal axis of the grip assembly. A lever may have a first end that is pivotally engaged at a first location with the housing, a second end opposite the first end, and a lever body extending between the first end and the second end. A linkage assembly may include: (a) a slide linkage having a first end, a second end opposite the first end, and a slide linkage body extending between the first end and the second end, where the first end of the slide linkage is configured to connect to a brake cable; (b) a bearing linkage having a first end pivotally engaged with the slide linkage, a second end opposite the first end, and a bearing linkage body extending between the first end and the second end, wherein the first end of the bearing linkage is nearer the second end of the slide linkage than the first end of the slide linkage; and (c) a pivot linkage having a first end pivotally engaged with the housing at a second location and also slidably engaged with the slide linkage and a second end opposite the first end that is pivotally engaged with the second end of the bearing linkage, where the first end of the pivot linkage is connected to the slide linkage nearer the first end of the slide linkage than the second end of the slide linkage. When the lever rotates toward the interior cavity, the second end of the bearing linkage and the second end of the pivot linkage may move towards the slide linkage causing the slide linkage to move away from the first opening. The second end of the slide linkage may connect to a first roller bearing. The first end of the lever may be enclosed within the housing and a portion of the lever body extends through the second opening. The housing body may include a first member having the first opening and a curved upper surface and a second member having the second opening, where the interior cavity is formed when the first member and the second member are joined together.

Still other aspects of this disclosure may relate to a grip assembly that includes a housing, a lever, and a linkage assembly. The housing may have a first end, a second end opposite the first end, and a housing body extending between the first end and the second end, where the first end has a first opening that extends into an interior cavity, and a second opening on a lower portion of the housing that extends into the interior cavity. The first opening may define a longitudinal axis of the grip assembly. The lever may have a first end that is pivotally engaged at a first location with the housing, a second end opposite the first end, and a lever body extending between the first end and the second end. The linkage assembly may include: (a) a slide linkage having a first end, a second end opposite the first end, and a slide linkage body extending between the first end and the second end, where the first end of the slide linkage is configured to connect to a piston; (b) a bearing linkage having a first end pivotally engaged with the slide linkage, a second end opposite the first end, and a bearing linkage body extending between the first end and the second end, where the first end of the bearing linkage is nearer the first end of the slide linkage than the second end of the slide linkage; and (c) a pivot linkage having a first end pivotally engaged with the housing at a second location and also slidably engaged with the slide linkage and a second end opposite the first end that is pivotally engaged with the second end of the bearing linkage, where the first end of the pivot linkage is connected to the slide linkage nearer the second end of the slide linkage than the first end of the slide linkage. When the lever rotates toward the interior cavity, the second end of the bearing linkage and the second end of the pivot linkage may move toward the slide linkage causing the slide linkage to move toward from the first opening. The first end of the lever is enclosed within the housing and a portion of the lever body extends through the second opening. The first opening may be located within a recess on the housing, where the recess is configured to receive a tubular member from a handlebar of a vehicle. The housing body may include a first member having the first opening and a curved upper surface and a second member having the second opening, where the interior cavity is formed when the first member and the second member are joined together. A first roller bearing may be connected near the first end of the slide linkage and the first roller bearing contacts an interior surface of the housing.

### BRIEF DESCRIPTION OF THE DRAWINGS

Example embodiments of the disclosure will now be described by way of example only and with reference to the accompanying drawings, in which:

FIG. 1 illustrates a perspective view of an exemplary grip assembly for a vehicle with a lever assembly according to aspects disclosed herein.

FIG. 2A illustrates a schematic of the exemplary grip assembly of FIG. 1 connected to a brake system of a vehicle according to aspects disclosed herein.

FIG. 2B illustrates a perspective view of the exemplary grip assembly of FIG. 1 connected to a vehicle according to aspects disclosed herein.

FIG. 3A illustrates a perspective exploded view of the exemplary grip assembly of FIG. 1 according to aspects disclosed herein.

FIG. 3B illustrates a perspective exploded view of the linkage assembly of FIG. 3A according to aspects disclosed herein.

FIG. 4 illustrates a front view of the exemplary grip assembly of FIG. 1 according to aspects disclosed herein.

FIG. 5 illustrates a rear view of the exemplary grip assembly of FIG. 1 according to aspects disclosed herein.

FIG. 6 illustrates a top view of the exemplary grip assembly of FIG. 1 according to aspects disclosed herein.

FIG. 7 illustrates a cross-sectional front view of the exemplary grip assembly of FIG. 1 according to aspects disclosed herein.

FIG. 8 illustrates a bottom view of the exemplary grip assembly of FIG. 1 according to aspects disclosed herein.

FIG. 9 illustrates a left side view of the exemplary grip assembly of FIG. 1 according to aspects disclosed herein.

FIG. 10 illustrates a right side view of the exemplary grip assembly of FIG. 1 according to aspects disclosed herein.

FIG. 11A illustrates a perspective view of the exemplary grip assembly of FIG. 1 with some components removed for clarity according to aspects disclosed herein.

FIG. 11B illustrates a perspective view of the exemplary grip assembly of FIG. 1 with some components removed for clarity according to aspects disclosed herein.

FIG. 11C illustrates a perspective view of the exemplary grip assembly of FIG. 1 with some components removed for clarity according to aspects disclosed herein.

FIG. 12 illustrates a perspective view of an alternate exemplary grip assembly for a vehicle with a lever system according to aspects disclosed herein.

FIG. 13 illustrates a perspective exploded view of the linkage assembly of the grip assembly of FIG. 12 according to aspects disclosed herein.

FIG. 14A illustrates a perspective view of the exemplary grip assembly of FIG. 12 with some components removed for clarity according to aspects disclosed herein.

FIG. 14B illustrates a perspective view of the exemplary grip assembly of FIG. 12 with some components removed for clarity according to aspects disclosed herein.

FIG. 14C illustrates a perspective view of the exemplary grip assembly of FIG. 12 with some components removed for clarity according to aspects disclosed herein.

### DETAILED DESCRIPTION

In the following description of various examples of lever assemblies that may be contained or partially contained within an enclosure. In one example, the lever assembly may be a portion of a grip assembly for a braking system of a vehicle as described herein. In this disclosure, reference is made to the accompanying drawings, which form a part hereof, and in which are shown by way of illustration various example structures and environments in which aspects of the disclosure may be practiced.

It is to be understood that other structures and environments may be utilized and that structural and functional modifications may be made from the specifically described structures without departing from the scope of the present disclosure. However, those skilled in the art will readily appreciate that the disclosure herein is not limited to the scales, dimensions, proportions, and/or orientations shown in the figures. Also, while the terms “center”, “top,” “bottom,” “front,” “back,” “left,” “right,” “side,” “rear,” and the like may be used in this specification to describe various example features and elements of the disclosure, these terms are used herein as a matter of convenience, e.g., based on the example orientations shown in the figures or the orientation during typical use. Additionally, the term “plurality,” as used herein, indicates any number greater than one, either disjunctively or conjunctively, as necessary, up to an infinite number. Nothing in this specification should be construed as requiring a specific three-dimensional orientation of structures in order to fall within the scope of this disclosure. The reader is advised that the attached drawings are not necessarily drawn to scale.

The examples described herein provide for a lever system that is located in or at least partially located in an enclosure such that the linkage assembly may allow for vertical or rotational movement of a lever to cause a linear movement through a linkage assembly. In some examples, the lever system may be located within an enclosure used for a grip assembly for a vehicle where the lever assembly may be connected to a braking or throttle system for a vehicle such as a bicycle, scooter, motorcycle, or other type of vehicle. The grip assembly may be used for other systems that requires linear movement that is activated by a rotating lever, such as a safety knife, or other type of system.

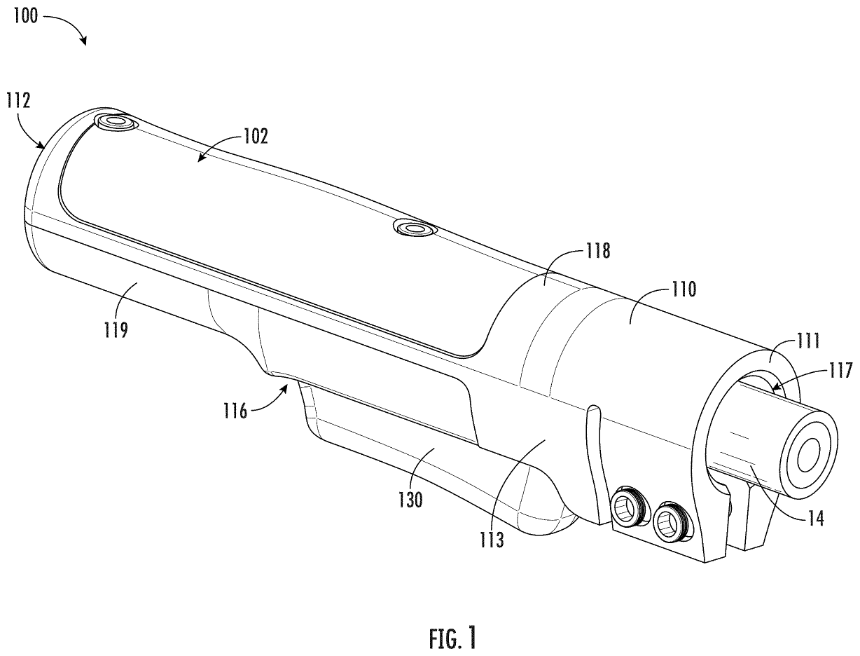

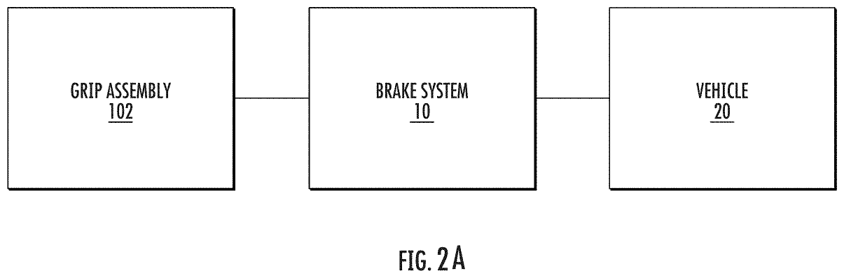

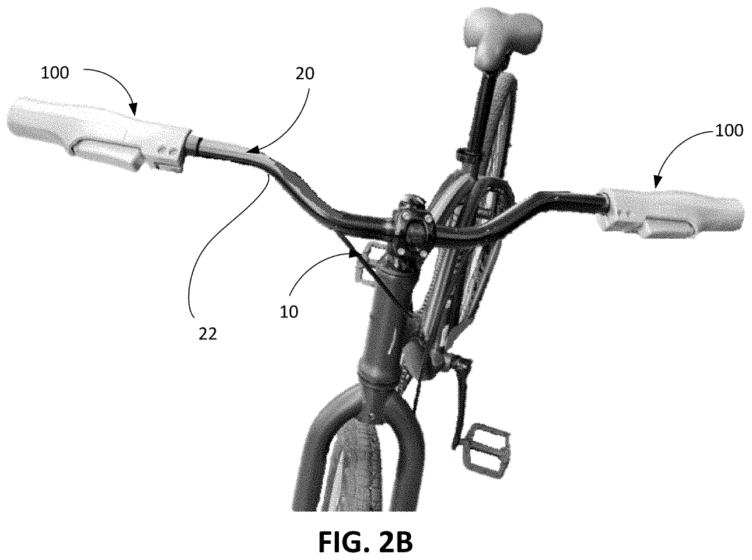

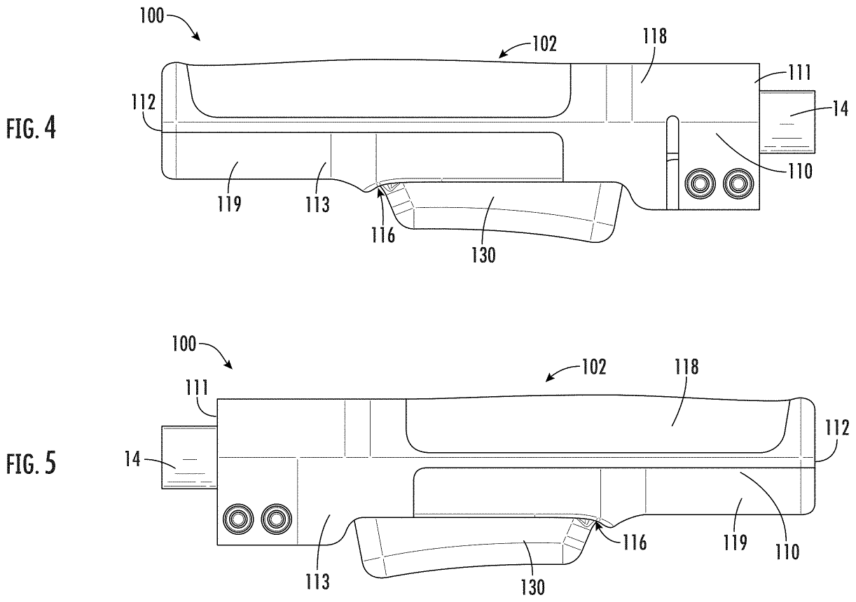

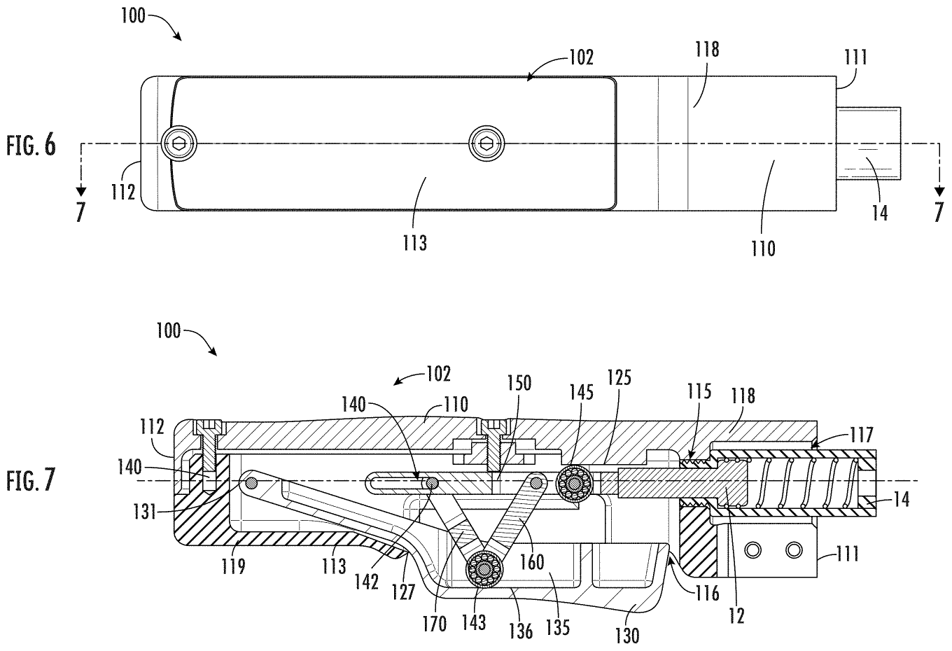

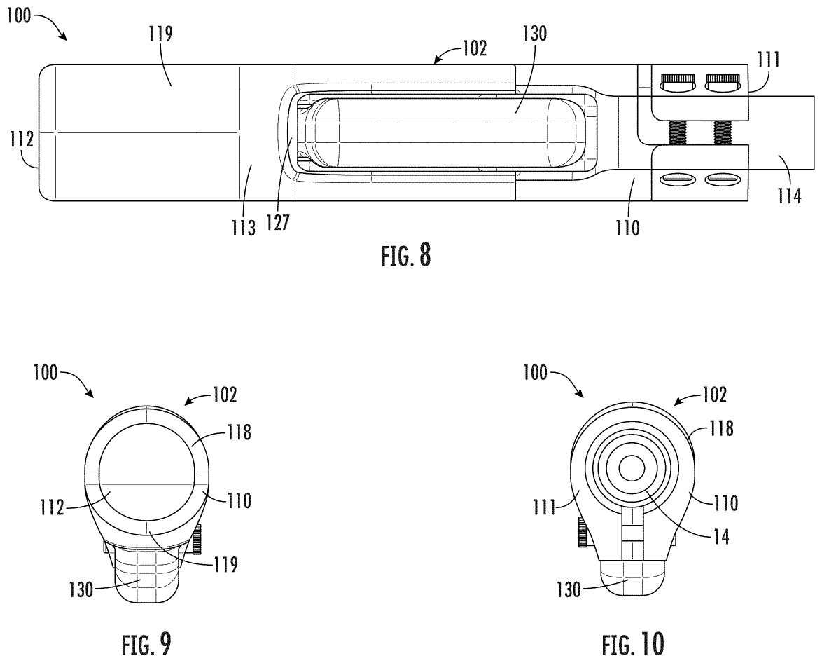

FIGS. 1-11C illustrate an example lever system 100 that is arranged as a grip assembly 102 to activate a braking system 10 of a vehicle 20. Braking system 10 in the examples of 1-11C may be hydraulic braking system with a hydraulic line 14 routed inside the handlebar 22 such that the hydraulic line is not externally visible at the intersection of the grip assembly 102. The grip assembly 102 may include a housing 110, a lever 130, and a linkage assembly 140, where the lever 130 may be at least partially located within an interior cavity 114 of the housing 110. The linkage assembly 140 may be at least partially enclosed within the housing 110 and may include three primary linkage members such as a slide linkage 150, a bearing linkage 160, and a pivot linkage 170, where the linkage members are pivotally engaged with each other. For example, the slide linkage 150 may be pivotally engaged with the bearing linkage 160 and the pivot linkage 170, while the bearing linkage 160 and the pivot linkage 170 may be pivotally engaged with each other. The lever 130 may also be pivotally attached to the housing 110 such that when a user applies a force to the lever 130, the lever 130 rotates toward the interior cavity 114 of the housing 110. As the lever 130 rotates toward the interior cavity 114, a portion of the bearing linkage 160 and a portion of the pivot linkage 170 both move toward the slide linkage 150 causing the slide linkage 150 to move along a longitudinal axis 104 of the grip assembly 102.

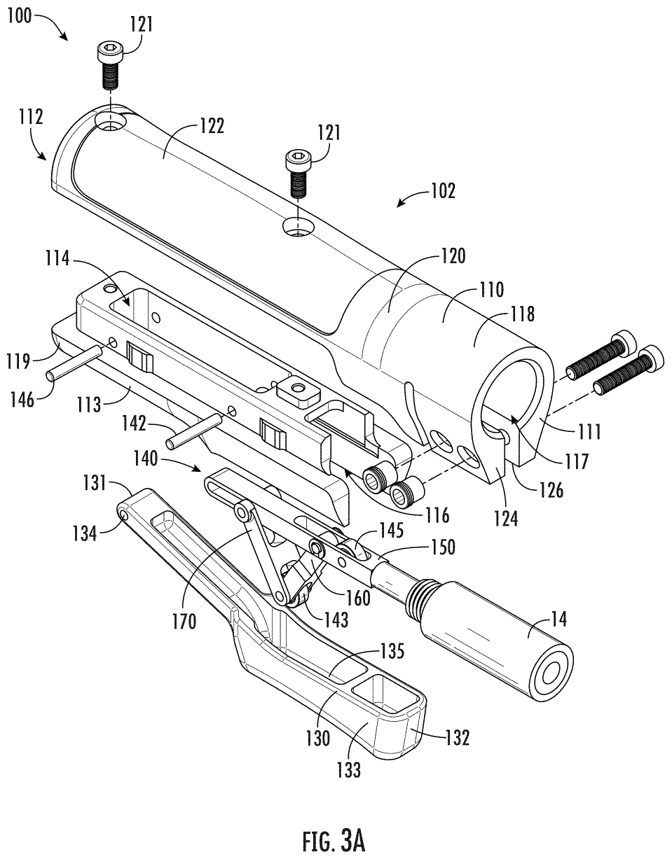

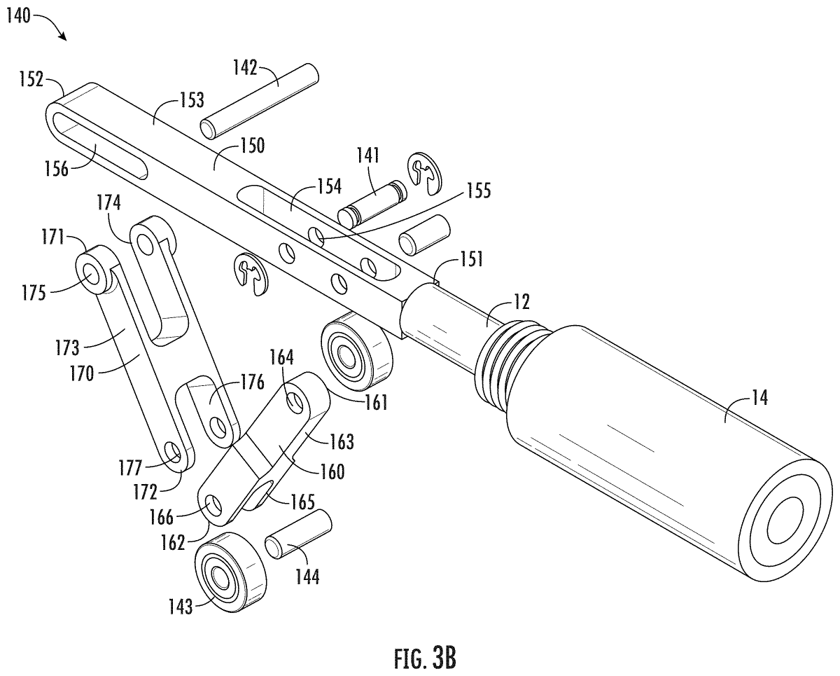

As shown in FIGS. 3A, 3B, 7, and 11A-C, the linkage assembly 140 may include three primary linkage members 150, 160, 170. The linkage members 150, 160, 170 may form a substantially triangular shape when connected. In this example, the slide linkage 150 may have a first end 151, a second end 152, and a slide linkage body 153 extending between the first end 151 and the second end 152. Similarly, the bearing linkage 160 may have a first end 161, a second end 162 opposite the first end 161, and bearing linkage body 163 extending between the first end 161 and the second end 162, and the pivot linkage 170 may have a first end 171, a second end 172 opposite the first end 171, and pivot linkage body 173 extending between the first end 171 and the second end 172. In some examples, the first end 151 of the slide linkage 150 is configured to connect to a piston 12 of the hydraulic braking system 10 such that the piston is configured to push fluid within a hydraulic line 14 of the hydraulic braking system 10.

The linkage assembly 140 may be arranged such that the first end 161 of the bearing linkage 160 is pivotally connected nearer the first end 151 of the slide linkage 150 than the second end 152 of the slide linkage 150. The first end 161 of the bearing linkage 160 may be received in a forward slot 154. Forward slot 154 may extend through an upper and lower surface of the slide linkage body 153. In addition, the first end 161 of the bearing linkage may have an opening 164 that receives a pin 141 that extends through the opening 164 and through an opening 155 of the slide linkage body 153 to pivotally connect the bearing linkage 160 to the slide linkage 150. Further, the pivot linkage 170 may be pivotally and slidably connected to the slide linkage 150 nearer the second end 152 of the slide linkage 150 than the first end 151. The pivot linkage body 173 may have a first clevis 174 at the first end 171 that receives a portion of the slide linkage body 153. The pivot linkage 170 may have a clevis 174, 176 at each end. First clevis 174 may receive a portion of the slide linkage body 153 and may connect to the slide linkage body 153 with a pin 142 that extends through an opening 175 in the first clevis 174 of the pivot linkage 170 through a rear slot 156. Rear slot 156 may extend through the front and rear surfaces of the slide linkage body 153. Pin 142 may also connect the slide linkage 150 and the pivot linkage 170 to the housing 110. By fixing the pin 142 to the housing 110, the slide linkage 150 may move relative to the housing 110 in a direction toward and away from opening 115. The second end 162 of the bearing linkage body may have a clevis 165 that receives a roller bearing 143, and the second end 172 of the pivot linkage 170 may have a second clevis 176 that receives the second end 162 of the bearing linkage 160. Pin 144 may extend through opening 166 in clevis 165, opening 177 in second clevis 176, and through the roller bearing 143 to connect the bearing linkage 160, the pivot linkage 170, and the roller bearing 143 together. In addition, a second roller bearing 145 may be mounted within the forward slot 154 of the slide linkage 150. The second roller bearing 145 may contact and roll along an interior guide surface 125 located on the first member 118 of the housing 110 as shown in FIG. 7. In some examples, the length of the bearing linkage 160 and the length of the pivot linkage 170 may be substantially the same length, or within 10 percent of the length of each other. The length of the bearing linkage 160 and the pivot linkage 170 may be defined as the distance between the center of the holes 264 and 266 of the bearing linkage 160 and the distance between the center of the holes 275 and 277 of the pivot linkage 170.

The lever 130 may have a first end 131, a second end 132, and a lever body 133 that extends from the first end 131 to the second end 132. The first end 131 of the lever 130 may be pivotally engaged to the housing 110 using pin 146 at a location that is aft of the of the pin 144 that connects the pivot linkage 170 and slide linkage 150 together, or the pin 146 may be located nearer the second end 112 of the housing than the first end 111 of the housing 110. Alternatively, the lever 130 may be pivotally attached to the housing 110 in other locations, such as pivotally attaching the lever 130 nearer the first end 111 of the housing 110 than the second end 112. The first end 131 of the lever body 133 may be enclosed in the interior cavity 114 within the housing 110 while a portion of the lever body 133 may extend through a lower opening 116 in a lower portion of the housing 110 such that a portion of the lever body 133 is exposed outside of the housing 110. Alternatively or optionally, the lever 130 may be pivotally attached to the housing 110 where the lever 130 is located completely outside of the housing 110.

The lever body 133 may include a pocket 135 with a bottom surface 136, such that the roller bearing 143 may contact the bottom surface 136. As the lever 130 rotates toward the interior cavity 114, the bottom surface 136 may exert a force on the roller bearing 143 causing the second end 162 of the bearing linkage 160 and the second end 172 of the pivot linkage 170 to move towards the slide linkage 150 causing the slide linkage 150 to move toward from a side opening 115 of the housing 110. As the slide linkage 150 moves toward the side opening 115, the piston 12 pushes the hydraulic fluid within the hydraulic brake system 10 causing the brakes to engage.

The housing 110 having a first end 111, a second end 112 opposite the first end 111, and a housing body 113 extending between the first end 111 and the second end 112. The first end 111 may have a side opening 115 that extends into an interior cavity 114, and a lower opening 116 on a lower portion of the housing 110 that also extends into the interior cavity 114. The side opening 115 may have a cylindrical shape that defines longitudinal axis 104 of the grip assembly 102. The housing 110 may also have a recess 117 formed at the first end 111 that is coaxial with the longitudinal axis 104. Recess 117 may receive a portion a tubular member of the handlebar 22 to connect the grip assembly 102 to the vehicle 20. The housing 110 may have a pair of opposing flanges 124 spaced on either side of an opening 126 that extends into recess 117. A pair of mechanical fasteners 128 may extend through openings in the flanges to secure the grip assembly 102 onto the tubular member of the vehicle 20.

The housing body 113 may include a first member 118 and a second member 119 that are releasably joined together. For example, the first member 118 and second member 119 may be releasably joined using mechanical fasteners 121 as in the illustrated example to allow for disassembly and any maintenance or repairs. The first member 118 may have a curved upper outward facing surface 120 and form the side opening 115 and an upper portion of the interior cavity 114. The second member 119 may have a curved lower outward facing surface and form the lower opening 116 and a lower portion of the interior cavity 114. In addition, the lower member 118 may be pivotally connected to the lever 130 and also have an opening to receive pin 142 to fix the location of the first end of the pivot linkage 170. The interior cavity 114 may be formed when the first member 118 and the second member 119 are joined together. An edge 127 of the lower opening 116 may contact a portion of the lever body 133 to provide a stop to limit rotation of the lever 130 in a direction away from the interior cavity 114.

In addition, the first member 118 of the housing may have a recess 122 along the first member 118 that may be configured to receive a flexible or polymer coating to enhance the feel of the grip assembly 102. In some examples, a removable covering may be fitted over the entire grip assembly 102 or over a majority of the grip assembly 102 to enhance the feel of the grip assembly 102. The removable covering may act as a moisture and dust barrier to keep unwanted moisture and debris from the interior components of the grip assembly 102.

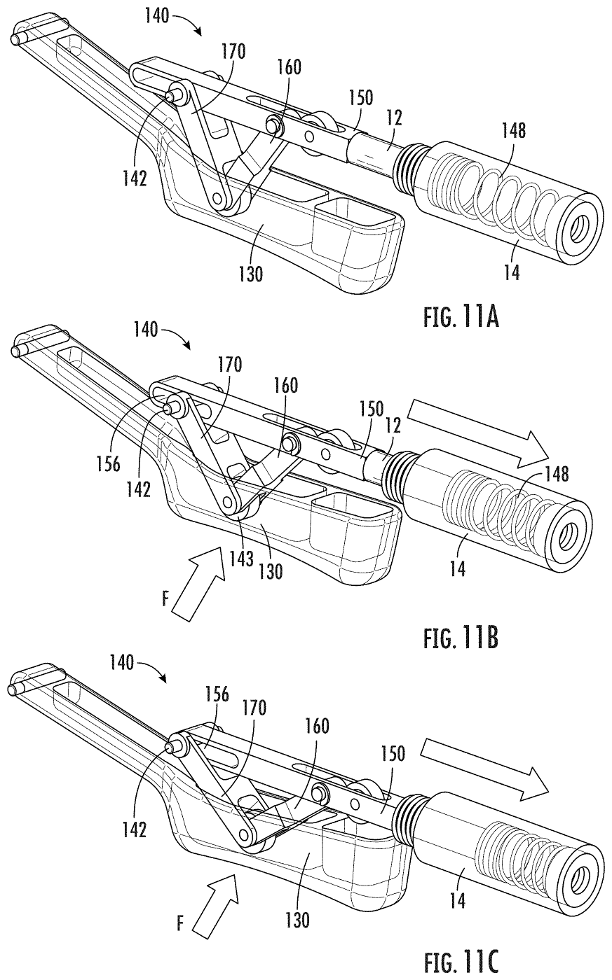

As best illustrated in FIGS. 11A-11C, the lever 130 may be rotated toward the interior cavity 114 of the housing 110 causing the slide linkage 150 to move linearly toward the opening 115 of the housing 110. In the illustrated examples in FIGS. 11A-11C, the housing 110 is removed to illustrate the linkage assembly 140 movement. In FIG. 11A, the lever 130 and linkage assembly 140 are in a normal or rest position. In FIG. 11B, the lever 130 has received a force, F, causing the lever 130 to rotate upward towards the slide linkage 150. As the lever 130 moves upwards, the roller bearing 143 begins to roll along the bottom surface 136 of the pocket 135 and the second end 162 of the bearing linkage 160 and the second end of the pivot linkage 170 begin to move upward. The upward movement of second ends 162, 172 causes the slide linkage 150 to move horizontally as the first end 171 of the pivot linkage 170 moves rearward within the rear slot 156. Because end 171 of the pivot linkage 170 is fixed to the housing 110, the slide linkage 150 moves towards the opening 115 of the housing beginning to push the fluid in the hydraulic line while also compressing spring 148 within the hydraulic line 14. As shown in FIG. 11C, the rear slot 156 acts as a stop for the slide linkage 150 as well as a stop for the lever's upward movement, such that a length of the rear slot 156 may determine the length of horizontal movement of the slide linkage 150. In this fully extended condition, the brakes of the vehicle may be fully engaged. Additionally, the angle between the pivot linkage 170 and the bearing linkage 160 may be greater in the fully extended condition as compared to the rest condition. As the force is removed from the lever 130, the spring 148 that was compressed when the brakes were engaged, exerts a force to return the linkage assembly 140 back to its rest condition.

The components for the grip assembly 102 such as the linkage members 150, 160, 170 as well as the lever 130 and housing members 118, 119 may be formed from metallic material such as but not limited to aluminum or non-metallic material such as a polymeric material. The components may be formed from known process such as molding, casting, forging, machining, or other methods known to one skilled in the art.

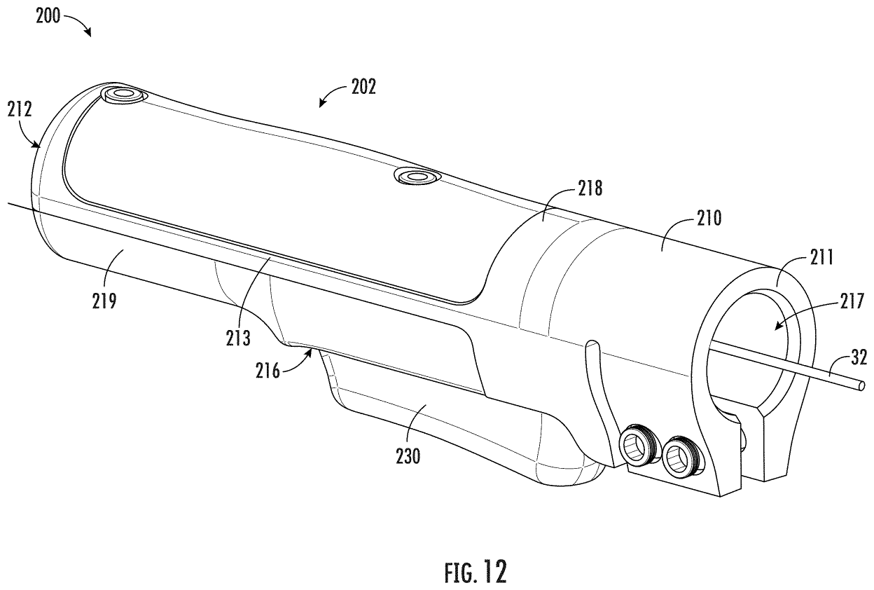

FIGS. 12-14C illustrate an example lever system 200 that is arranged as a grip assembly 202 to activate a cable braking system 10 of a vehicle 20. For the example of FIGS. 12-14C, the features are referred to using similar reference numerals under the “2xx” series of reference numerals, rather than “1xx” as used in the embodiment of FIGS. 1-11C. Accordingly, certain features of the grip assembly 202 that were already described above with respect to grip assembly 102 of FIGS. 1-11C may be described in lesser detail, or may not be described at all. Grip assembly 202 may be connected to a brake system 10 that is arranged a cable oriented brake system 10 with a cable 32 routed inside the handlebar 22 such that the cable 32 is not externally visible at the intersection of the grip assembly 202. The grip assembly 202 may include a housing 210, a lever 230, and a linkage assembly 240, where the lever 230 may be at least partially located within an interior cavity 214 of the housing 210. The linkage assembly 240 may include three primary linkage members such as a slide linkage 250, a bearing linkage 260, and a pivot linkage 270, where the linkage members are pivotally engaged with each other. For example, the slide linkage 250 may be pivotally engaged with the bearing linkage 260 and the pivot linkage 270, while the bearing linkage 260 and the pivot linkage 270 may be pivotally engaged with each other. The lever 230 may also be pivotally attached to the housing 210 such that when a user applies a force to the lever 230, the lever 230 rotates toward the interior cavity 214 of the housing 210. As the lever 230 rotates toward the interior cavity 214, a portion of the bearing linkage 260 and a portion of the pivot linkage 270 both move toward the slide linkage 250 causing the slide linkage 250 to move along a longitudinal axis 204 of the grip assembly 202.

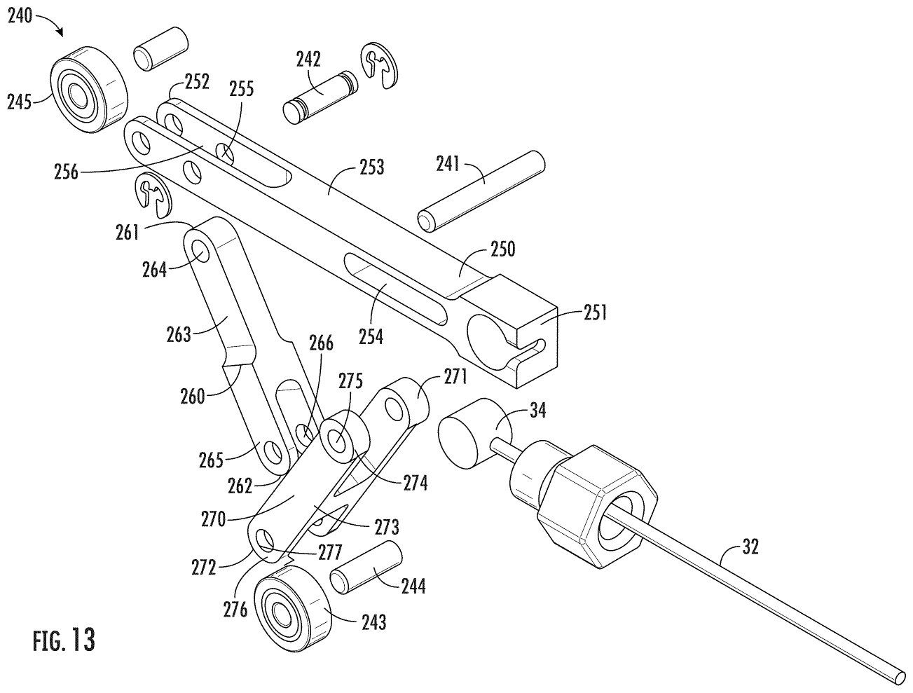

As shown in FIG. 13, the linkage assembly 240 may include three primary linkage members. In this example, the slide linkage 250 may have a first end 251, a second end 252, and a slide linkage body 253 extending between the first end 251 and the second end 252. Similarly, the bearing linkage 260 may have a first end 261, a second end 262 opposite the first end 261, and bearing linkage body 263 extending between the first end 261 and the second end 262, and the pivot linkage 270 may have a first end 271, a second end 272 opposite the first end 271, and pivot linkage body 273 extending between the first end 271 and the second end 272. In some examples, the first end 251 of the slide linkage 250 may have a receiver 259 that is configured an engaging member 34 of the cable 32 of the cable braking system 10. The linkage assembly 240 may be arranged such that the first end 261 of the bearing linkage 160 is pivotally connected nearer the second end 252 of the slide linkage 250 than the first end 251 of the slide linkage 250. The first end 261 of the bearing linkage 260 may be received in a rear slot 256. Rear slot 256 may extends through an upper and lower surface of the slide linkage body 253 and may have the form of a clevis. In addition, the first end 261 of the bearing linkage may have an opening 264 that receives a pin 242 that extends through the opening 264 and through an opening 255 of the slide linkage body 253 to pivotally connect the bearing linkage 260 to the slide linkage 250. Pin 242 may also connect the slide linkage 250 and the bearing linkage 260 to the housing 210. By fixing the pin 242 to the housing 210, the slide linkage 250 may move relative to the housing 210. Further the pivot linkage 270 may be pivotally and slidably connected to the slide linkage 250 nearer the first end 251 of the slide linkage 250 than the second end 252. The pivot linkage body 273 may have a first clevis 274 at the first end 271 that receives a portion of the slide linkage body 253. The pivot linkage body 273 may be connected to the slide linkage 250 with a pin 241 that extends through an opening 275 in the first clevis 274 of the pivot linkage 270 through a forward slot 254. Forward slot 254 may extend through the front and rear surfaces of the slide linkage body 253. The second end 262 of the bearing linkage body may have a clevis 265 that receives a roller bearing 243, and the second end 272 of the pivot linkage 270 may have a second clevis 276 that receives the second end 262 of the bearing linkage 260. Pin 244 may extend through opening 266 in clevis 265, opening 277 in second clevis 276, and through the roller bearing 243 to connect the bearing linkage 260, the pivot linkage 270, and the roller bearing 243 together. In addition, a second roller bearing 245 may be mounted within the rear slot 256 of the slide linkage 250. The second roller bearing 145 may contact and roll along an interior surface of the lever 230.

The lever 230 may have a first end 231, a second end 232, and a lever body 233 that extends from the first end 231 to the second end 232. The first end 231 of the lever 230 may be pivotally engaged with the housing 210 at a location that is aft of the pin 242 that connects the bearing linkage 260 and slide linkage 250 together. The first end 231 of the lever body 233 may be enclosed in the interior cavity 214 within the housing 210 while a portion of the lever body 233 may extend through a lower opening 216 in a lower portion of the housing 210. The lever body 233 may include a pocket 235 with a bottom surface 236, such that the roller bearing 243 may contact the bottom surface 236. As the lever 230 rotates toward the interior cavity 214, the bottom surface 236 may exert a force on the roller bearing 243 causing the second end 262 of the bearing linkage 260 and the second end 272 of the pivot linkage 270 to move towards the slide linkage 250 causing the slide linkage 250 to move away from a side opening 215 of the housing 210. As the slide linkage 250 moves away the side opening 215 pulling the cable 32 causing the braking system 10 to engage a wheel on the vehicle 20.

The housing 210 having a first end 211, a second end 212 opposite the first end 211, and a housing body 213 extending between the first end 211 and the second end 212. The first end 211 may have a side opening 215 that extends into an interior cavity 214, and a lower opening 216 on a lower portion of the housing 210 that also extends into the interior cavity 214. The side opening 215 may have a cylindrical shape that defines longitudinal axis 204 of the grip assembly 202. The housing 210 may also have a recess 217 formed at the first end 211 that is coaxial with the longitudinal axis 204. Recess 217 may receive a portion a tubular member of the handlebar 22 to connect the grip assembly 202 to the brake system 10 of the vehicle 20. The housing body 213 may include a first member 218 and a second member 219 that are releasably joined together. The first member 218 may have a curved upper outward facing surface and form the side opening 215 and an upper portion of the interior cavity 214. The second member 219 may have a curved lower outward facing surface and form the lower opening 216 and a lower portion of the interior cavity 214. The interior cavity 214 may be formed when the first member 218 and the second member 219 are joined together. An edge 227 of the lower opening 216 may contact a portion of the lever body 233 to provide a stop to limit rotation of the lever 230 in a direction away from the interior cavity 214.

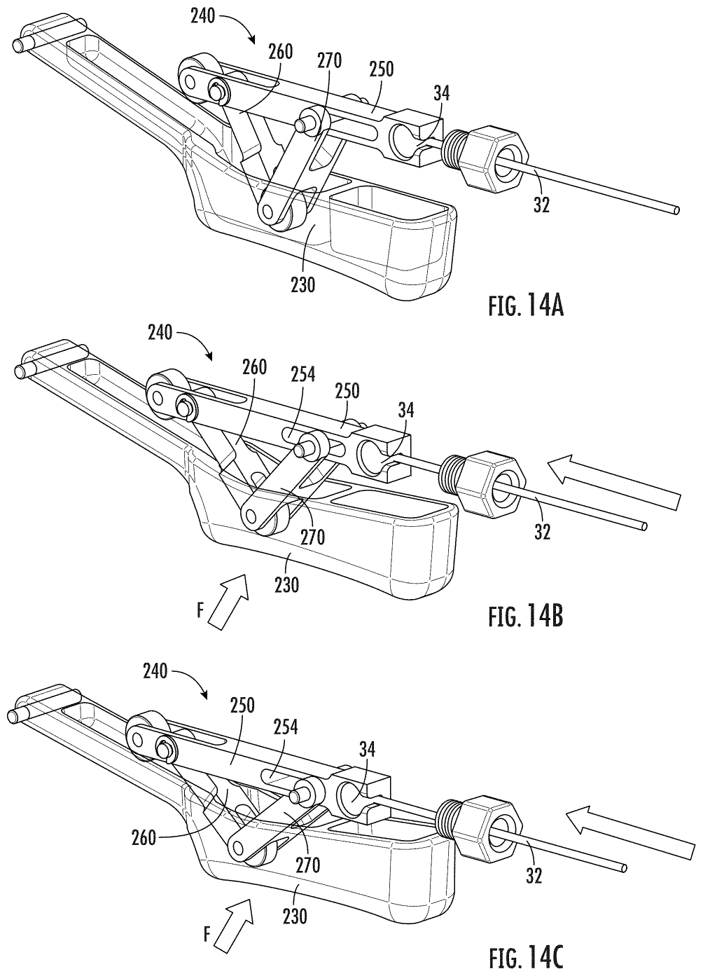

As best illustrated in FIGS. 14A-14C, the lever 230 may be rotated toward the interior cavity 214 of the housing 210 causing the slide linkage 250 to move linearly toward the opening 215 of the housing 210. In the illustrated examples in FIGS. 14A-14C, the housing 210 is removed to illustrate the linkage assembly 240 movement. In FIG. 14A, the lever 230 and linkage assembly 240 are in a normal or rest position. In FIG. 14B, the lever 230 has received a force, F, causing the lever 230 to rotate upward towards the slide linkage 250. As the lever 230 moves upwards, the roller bearing 243 begins to roll along the bottom surface 236 of the pocket 235 and the second end 262 of the bearing linkage 260 and the second end 272 of the pivot linkage 270 begin to move upward. The upward movement of second ends 262, 272 causes the slide linkage 250 to move horizontally away from the side opening 215 pulling the cable 32 into the housing 210. As the slide linkage 150 moves, the forward slot 254 moves relative to first end 271 of the pivot linkage 270. As shown in FIG. 11C, the forward slot 254 acts as a stop for the slide linkage 250 as well as a stop for the lever's upward movement, such that a length of the forward slot 254 may determine the length of horizontal movement of the slide linkage 250. In this fully extended condition, the brakes of the vehicle may be fully engaged. Additionally, the angle between the pivot linkage 270 and the bearing linkage 260 may be greater in the fully extended condition as compared to the rest condition.

The present disclosure is disclosed above and in the accompanying drawings with reference to a variety of examples and embodiments. The purpose served by the disclosure, however, is to provide examples of the various features and concepts related to the disclosure, not to limit the scope of the disclosure. One skilled in the relevant art will recognize that numerous variations and modifications may be made to the aspects described above without departing from the scope of the present invention, as defined by the appended claims. The claims are not to be limited to details of the preferred embodiment except as stated to exist in the claims, and definitions of claim terms are not to be used as a subterfuge to limit the claims to details of the preferred embodiments by defining claim terms narrowly such that they incorporate details of the preferred embodiment.

What is claimed is:

1. A lever system comprising:
a housing having a first end, a second end opposite the first end, and a housing body extending between the first end and the second end, wherein the first end has a first opening that extends into an interior cavity, and a second opening on a lower portion of the housing that extends into the interior cavity, wherein the first opening defines a longitudinal axis;
a lever having a first end that is pivotally engaged at a first location with the housing, a second end opposite the first end, and a lever body extending between the first end and the second end;
a linkage assembly comprising:
a slide linkage having a first end, a second end opposite the first end, and a slide linkage body extending between the first end and the second end;
a bearing linkage having a first end pivotally engaged with the slide linkage and a second end opposite the first end;
a pivot linkage having a first end pivotally engaged with the housing at a second location and also slidably engaged with the slide linkage and a second end opposite the first end that is pivotally engaged with the second end of the bearing linkage; and
wherein when the lever rotates toward the interior cavity, the second end of the bearing linkage and the second end of the pivot linkage both move toward the slide linkage causing the slide linkage to move along the longitudinal axis.

2. The lever system of claim 1, wherein the slide linkage moves toward the first opening.

3. The lever system of claim 1, wherein the slide linkage moves away from the first opening.

4. The lever system of claim 1, wherein the slide linkage has a receiver near the first end that receives a cable, wherein the cable is part of a braking system for a vehicle.

5. The lever system of claim 1, wherein the slide linkage connects to a piston that is configured to attach to a hydraulic line of a braking system for a vehicle.

6. The lever system of claim 1, wherein the second end of the bearing linkage and the second end of the pivot linkage are connected to a first roller bearing.

7. The lever system of claim 6, wherein the lever body includes a pocket with a bottom surface, wherein the first roller bearing contacts the bottom surface.

8. The lever system of claim 1, wherein the first end of the lever is enclosed within the housing and a portion of the lever body extends through the second opening.

9. The lever system of claim 1, wherein an edge of the second opening provides a stop to limit rotation of the lever in a direction away from the interior cavity.

10. The lever system of claim 1, wherein the housing body includes a first member having the first opening and a curved upper surface and a second member having the second opening, wherein the interior cavity is formed when the first member and the second member are joined together.

11. The lever system of claim 10, wherein the first member and the second member are releasably joined together.

12. A grip assembly comprising:
a housing having a first end, a second end opposite the first end, and a housing body extending between the first end and the second end, wherein the first end has a first opening that extends into an interior cavity, and a second opening on a lower portion of the housing that extends into the interior cavity, wherein the first opening defines a longitudinal axis;
a lever having a first end that is pivotally engaged at a first location with the housing, a second end opposite the first end, and a lever body extending between the first end and the second end;
a linkage assembly comprising:
a slide linkage having a first end, a second end opposite the first end, and a slide linkage body extending between the first end and the second end, wherein the first end of the slide linkage is configured to connect to a brake cable;
a bearing linkage having a first end pivotally engaged with the slide linkage, a second end opposite the first end, and a bearing linkage body extending between the first end and the second end, wherein the first end of the bearing linkage is nearer the second end of the slide linkage than the first end of the slide linkage;
a pivot linkage having a first end pivotally engaged with the housing at a second location and also slidably engaged with the slide linkage and a second end opposite the first end that is pivotally engaged with the second end of the bearing linkage, wherein the first end of the pivot linkage is connected to the slide linkage nearer the first end of the slide linkage than the second end of the slide linkage; and
wherein when the lever rotates toward the interior cavity, the second end of the bearing linkage and the second end of the pivot linkage move towards the slide linkage causing the slide linkage to move away from the first opening.

13. The grip assembly of claim 12, wherein the second end of the slide linkage connects to a first roller bearing.

14. The grip assembly of claim 12, wherein the first end of the lever is enclosed within the housing and a portion of the lever body extends through the second opening.

15. The grip assembly of claim 12, wherein the housing body includes a first member having the first opening and a curved upper surface and a second member having the second opening, wherein the interior cavity is formed when the first member and the second member are joined together.

16. A grip assembly for a vehicle comprising:
a housing having a first end, a second end opposite the first end, and a housing body extending between the first end and the second end, wherein the first end has a first opening that extends into an interior cavity, and a second opening on a lower portion of the housing that extends into the interior cavity, wherein the first opening defines a longitudinal axis;
a lever having a first end that is pivotally engaged at a first location with the housing, a second end opposite the first end, and a lever body extending between the first end and the second end;
a linkage assembly comprising:
a slide linkage having a first end, a second end opposite the first end, and a slide linkage body extending between the first end and the second end, wherein the first end of the slide linkage is configured to connect to a piston;
a bearing linkage having a first end pivotally engaged with the slide linkage, a second end opposite the first end, and a bearing linkage body extending between the first end and the second end, wherein the first end of the bearing linkage is nearer the first end of the slide linkage than the second end of the slide linkage;
a pivot linkage having a first end pivotally engaged with the housing at a second location and also slidably engaged with the slide linkage and a second end opposite the first end that is pivotally engaged with the second end of the bearing linkage, wherein the first end of the pivot linkage is connected to the slide linkage nearer the second end of the slide linkage than the first end of the slide linkage; and
wherein when the lever rotates toward the interior cavity, the second end of the bearing linkage and the second end of the pivot linkage move towards the slide linkage causing the slide linkage to move toward from the first opening.

17. The grip assembly of claim 16, wherein the first end of the lever is enclosed within the housing and a portion of the lever body extends through the second opening.

18. The grip assembly of claim 17, wherein the first opening is located within a recess on the housing, wherein the recess is configured to receive a tubular member from a handlebar of a vehicle.

19. The grip assembly of claim 16, wherein the housing body includes a first member having the first opening and a curved upper surface and a second member having the second opening, wherein the interior cavity is formed when the first member and the second member are joined together.

20. The grip assembly of claim 16, wherein a first roller bearing is connected near the first end of the slide linkage and the first roller bearing contacts an interior surface of the housing.
